(19) United States
(12) Patent Application Publication
(10) Pub. No.: US 2019/0204462 A1
(43) Pub. Date: Jul. 4, 2019

(54) METHOD FOR CALIBRATING A HIGH VOLTAGE GENERATOR OF AN X-RAY TUBE IN A RADIOGRAPHIC SYSTEM

(71) Applicant: YXLON International GmbH, Hamburg (DE)

(72) Inventor: André SCHU, Schwarzenbek (DE)

(21) Appl. No.: 16/238,831

(22) Filed: Jan. 3, 2019

(30) Foreign Application Priority Data
Jan. 4, 2018 (DE) 102018100131.2

(51) Int. Cl. G01T 7/00

(52) U.S. Cl. CPC G01T 7/005

(57) ABSTRACT

Method for calibrating a high-voltage generator of an X-ray tube in a tube-detector system including: introducing at least two filters of different materials into an X-ray beam between the X-ray tube and a detector, the first filter material having its K-edge outside and the second filter material having its K-edge inside a predefinable high-voltage range; setting a nominal high-voltage value at the generator and recording an X-ray image of the filters through the detector; recording X-ray images of the filters at other nominal values; forming a relationship between signals in the X-ray images for the first and second materials for each nominal high-voltage value; determining the nominal high-voltage value by reference to the setting at the generator where the relationship has an extreme value; calculating a difference between this nominal high-voltage value and the K-edge value of the second material; and correcting the nominal high-voltage value by the calculated difference.

### CROSS REFERENCE TO RELATED APPLICATION

This application claims priority to German patent application number DE 10 2018 100131.2, filed on Jan. 4, 201, the contents of which are incorporated by reference herein in its entirety.

### BACKGROUND OF THE INVENTION

### 1. Field of the Invention

The invention relates to a method for the calibration of a high-voltage generator of an X-ray tube in a tube-detector system in a predefinable high-voltage range.

### 2. Description of Related Art

In an X-ray tube, the applied high voltage defines the kinetic energy of the electrons and this in turn defines the maximum energy of the X-radiation. Because the absorption of the X-radiation in materials decreases as the energy of the X-radiation increases, the maximum energy of the X-radiation is of major importance for radiation protection. The lead thicknesses are designed on the basis of the maximum high voltage that can be set. The centering and also the focusing inside the X-ray tube are likewise set on the basis of the high voltage. It is therefore very important that the high voltage is correctly set by the high-voltage generator. Testing of the high voltage, for example using a high-voltage divider, is associated with a considerable outlay as a high-voltage divider has to be electrically connected between the X-ray tube and the high-voltage generator. This regularly means that two high-voltage cables have to be laid. Such a measurement setup represents a considerable modification outlay.

### SUMMARY OF THE INVENTION

An object of the invention is to provide a simple means by which the applied high voltage in an X-ray tube can be tested. The object is achieved by a method with the features of claim 1. This provides a calibration method with the following steps:

a) introducing a filter set with at least two filters made of different materials into the X-ray beam between the X-ray tube and an X-ray detector, wherein the first material of the first filter has its K-edge outside the predefinable high-voltage range and the second material of the second filter has its K-edge inside the predefinable high-voltage range;

b) setting a nominal value of the high voltage at the X-ray tube and recording an X-ray image of the filter set through the X-ray detector;

c) recording further X-ray images of the filter set at other nominal values of the high voltage at the X-ray tube;

d) forming the relationship between the signals in the X-ray images for the first material and the second material for each individual nominal value of the high voltage;

e) determining the nominal value of the high voltage, at which the relationship has an extreme value;

f) calculating the difference between this nominal value of the high voltage and the value of the K-edge of the second material;

g) correcting the nominal value of the high voltage by the calculated difference.

The measurement method is thereby simplified, as the required signals can be measured at the same time using the same measuring device. The measuring equipment to be used is available in a standard X-ray system.

Because a (flat panel) detector is used instead of a dosimeter known from the state of the art, an advantage which arises is that the surface of the X-ray detector can be divided up into individual segments, whereby it is possible to place a series of different (test) filters—also significantly more than the at least two according to the invention—directly in front of the X-ray detector and thus to test several high-voltage values without having to alter the measurement setup in the meantime. Because instead of the fluorescence signal a transmission signal of a material—that of the first filter—is measured, the edge energy of which lies far away from the edge energy of the second filter, the K-edge of which lies in the range of the high voltage to be measured, no additional shielding is necessary in order to separate the signal from the scattered radiation unlike when a fluorescence signal is used. A setup using the transmission signal also requires less space than in the case of a fluorescence signal. In the small cubicles of material testing facilities, the problem of having to find the space is thus circumvented by being able to measure the fluorescence signal at a suitable distance with suitable shielding. The filter set is placed as close as possible in front of the X-ray detector, so that the signals are superimposed as little as possible behind the individual filters. The measurement setup is thus reduced to four parts and a measuring arrangement. The signals obtained according to the invention are set in relationship to one another and the energy of the electrons is determined from the relationship curve and the known edge energy of the respective filter.

An advantageous development of the invention provides that a prefilter for the beam hardening of the X-ray beam is introduced between X-ray tube and X-ray detector. An improvement in the signals and thus a more accurate evaluation of the results is achieved thereby.

A further advantageous development of the invention provides that the prefilter is made of iron, copper or aluminum. With these prefilters it is possible to harden the X-radiation and at the same time to achieve a sufficient brightness with the X-ray detectors. The beam hardening makes an improvement in the signals and thus a faster detection of the photoelectric effect possible for better determination of the maximum energy of the electrons and thus of the applied high voltage.

A further advantageous development of the invention provides that the prefilter has a thickness in the range of from 0.1 mm to 10 mm, preferably between 0.1 mm and 3 mm. The prefilters serve for the beam hardening and must be adapted to the high-voltage range to be tested. In the case of voltages in the region of 40 kV, hardening is not required as the first filter, also called the test filter, and the second filter, also called the reference filter, already absorb very strongly. In the case of voltages in the region of 90 kV, a prefilter with 2-3 mm iron brings a considerable improvement in the signals.

A further advantageous development of the invention provides that the nominal values of the high voltage are passed through either in ascending or descending order. It is thus not necessary to jump back and forth when setting the high-voltage values.

A further advantageous development of the invention provides that the second material of the filter set is selected from the following group of materials: uranium, thorium, bismuth, lead, thallium, mercury, gold, platinum, iridium, tungsten, tantalum, erbium, gadolinium, neodymium, cerium, barium, tellurium, tin, silver, palladium, molybdenum. It is thus possible to calibrate a high-voltage generator in the voltage range of from approximately 20 kV to approximately 120 kV. The high-voltage measurement here is accurate to within less than ±1%.

A further advantageous development of the invention provides that the filter set has a further two filters from the named group of second materials. The more filters that are used, the larger the range of the high voltage in which a calibration of the high-voltage generator can be carried out without replacing the filter set.

A further advantageous development of the invention provides that the first material of the filter set is copper. The K-edge of copper, at 8.98 kV, lies sufficiently far away from the K-edges of the second filter materials which lie in the range of the high-voltage values in which the calibration is carried out.

A further advantageous development of the invention provides that at least one of the filters of the filter set has a thickness in the range of from 1 μm to 10 mm, preferably between 10 μm and 2 mm. The thickness of the respective filters is chosen such that the signal strength is sufficiently strong behind the respective filter. In the case of low voltages, such as for example in the region of 40 kV, very thin filters with a thickness of a few hundred micrometers are required as the X-radiation has only a low penetration depth at these energies. In the case of higher voltages, such as for example 80 kV, the filters have to be chosen thicker. The chosen thicknesses here are usually several hundred micrometers to a few millimeters.

### BRIEF DESCRIPTION OF THE DRAWINGS

Further advantages and details of the invention are explained with reference to the embodiment examples represented in the figures. The figures show:

FIG. 1 a schematic representation of a setup for carrying out the method according to the invention,

FIG. 2 a top view of a filter set for carrying out the method according to the invention, and

FIG. 3 a representation of the absorption coefficients of a first and a second filter material.

### DETAILED DESCRIPTION OF THE INVENTION

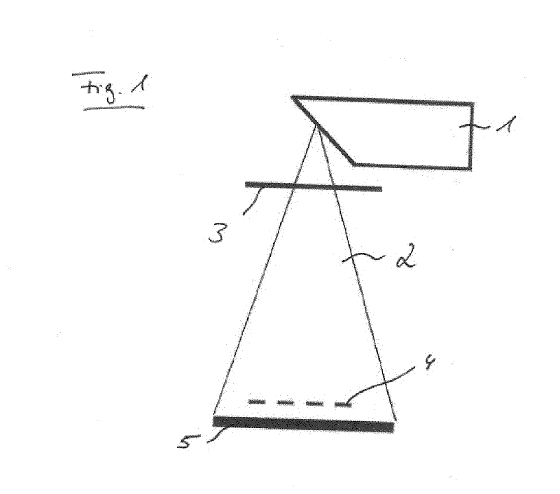

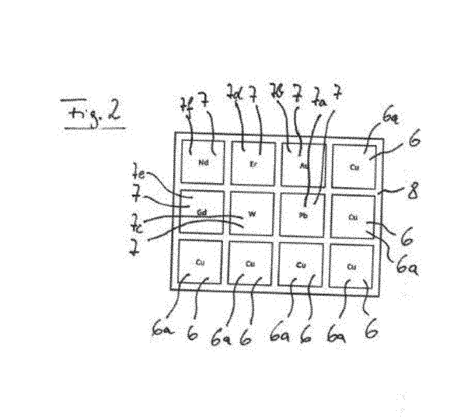

First the setup of an arrangement for carrying out a calibration method according to the invention for a high-voltage generator of an X-ray tube 1 is described briefly with reference to FIGS. 1 and 2. The performance of the calibration method according to the invention is then described in detail.

FIG. 1 shows a schematic setup for carrying out a method according to the invention. An X-ray tube 1 emits an X-ray beam 2, the energy and wavelength of which are dependent on the high voltage actually applied at the X-ray tube 1. A prefilter 3 which serves for the beam hardening is arranged in the X-ray beam 2. In the vicinity of an X-ray detector 5—an area detector in the embodiment example—a filter set 4 is arranged parallel to the surface of the X-ray detector 5. A small iron plate with a thickness of 2 mm can, for example, be used as prefilter 3.

In an X-ray tube, the applied high voltage defines the kinetic energy of the electrons and this in turn defines the maximum energy of the X-radiation. Because the absorption of the X-radiation in materials decreases as the energy of the X-radiation increases, the maximum energy of the X-radiation is of major importance for radiation protection. Testing of the high voltage is currently associated with a considerable outlay as the X-ray tube 1 and the high-voltage generator have to be electrically connected to a voltage divider.

FIG. 2 shows the top view of an embodiment example of a filter set 4 required for carrying out a calibration method according to the invention. A total of twelve filters made of (in some cases) different materials are mounted on a carrier plate 8 made of a rigid material which is as transparent as possible for the X-ray beam 2, for example carbon, plexiglass or carbon fiber. According to the invention, a first material 6 is absolutely necessary, the K-edge 9 of which lies far away from the energy of the X-ray beam 2, at the value of the high voltage for which the high-voltage generator is to be calibrated.

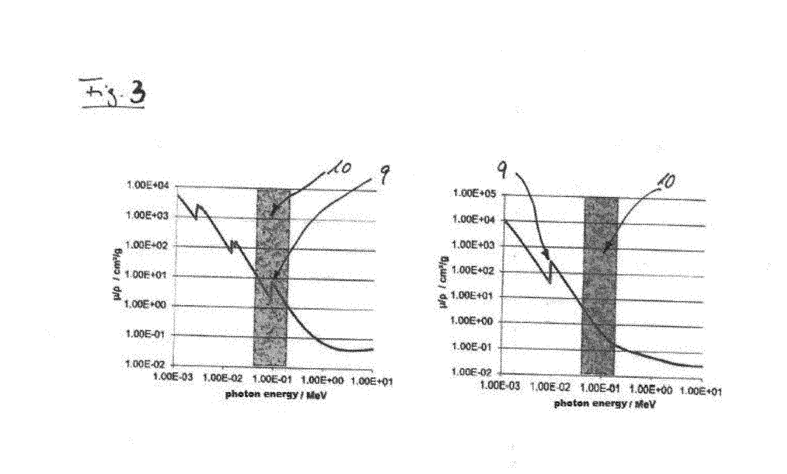

In the present embodiment example, copper is used as first material 6a for a first filter 6. The absorption coefficient thereof is represented in the right part of FIG. 3. The K-edge 9 of copper, at a photon energy of 8.98 keV, lies clearly below a calibration range 10 represented in grey. A total of six first filters 6 made of the first material 6a are present and are arranged along the lower and right-hand edge of the carrier plate 8. The first filters 6 have a size of 25 mm×25 mm.

The remaining second filters 7 are made of six different second materials 7a-f, lead, tungsten, gadolinium, gold, erbium and neodymium. The second materials 7a-f must have the property that their respective K-edge lies inside the calibration range 10. It can be seen from the course of the absorption coefficient of lead as second material 7a that is represented in the left part of FIG. 3 that the K-edge 9 thereof lies at 88.0 keV and is located in the calibration range 10 represented in grey; its other edges lie clearly outside this calibration range 10 at lower photon energies. For the other second materials 7b-f, the same applies correspondingly: their respective K-edge lies at 80.7 keV for gold (second material 7b), 69.5 keV for tungsten (second material 7c), 57.5 keV for erbium (second material 7d), 50.24 keV for gadolinium (second material 7e) and 43.57 keV for neodymium (second material 70. The second filters 7 are the same size as the first filters 6, i.e. 25 mm×25 mm.

In the following, the method according to the invention will be described in more detail. In order to carry out the calibration method according to the invention the filter set 4 is brought into the X-ray beam 2, as shown in FIG. 1. After completion of the calibration method, it is removed from the X-ray beam 2 in order not to disrupt the work of the equipment, for example in the case of the nondestructive examination of castings.

After a nominal value has been set at the high-voltage generator, first the transmission signals behind the filter set 4 are measured for each first filter 6—also called reference filter—and each second filter 7—also called test filter. The precise definition of the filter thicknesses and materials is dependent on the energy of the X-ray beam 2 at the high voltage actually applied. In the following, for simplification only the filters 6, 7 with the first material 6a (copper) and the second material 7a lead are described. The thicknesses used for these two materials 6a, 7a are, for example, 0.5 mm for lead and 2 mm for copper. The applied high voltage is varied over a range in predefined increments, for example of 0.1 kV. The measured signals are then set in relationship to one another and plotted as a function of the high voltage. The maximum of the relationship curve is determined; this represents the energy of the K-edge 9 of lead. Alternatively, two straight lines can be determined from the relationship curve by approximation: one for values below the K-edge 9 of lead and another for values above the K-edge 9 of lead. These two straight lines intersect at the energy which corresponds to the K-edge 9 of the test filter (second filter 7), i.e. of lead (88.005 keV).

If a calibration of the high-voltage generator is to be effected over a wide voltage range, for example from 40 kV to 95 kV, it makes sense, for different sections of this voltage range, to use the relationship values for various second materials 7a-7f in relation to the constant first material 6a, copper, the respective K-edge 9 of which lies in the voltage range just passed through. At the beginning, a voltage of 40 kV and a target output of 10 W are set. After the transmission signals for the filters have been recorded, the voltage is increased by, for example, 0.1 kV—nominally at the high-voltage generator—and the transmission signals are recorded again. This is carried out up to the desired final voltage. Thus, for example, gadolinium (second material 7e with a K-edge 9 at 50.24 keV) can be used in the range of from 45 kV to 55 kV, erbium (second material 7d with a K-edge 9 at 57.49 keV) from 55 kV to 65 kV, tungsten (second material 7c with a K-edge 9 at 69.53 keV) from 65 kV to 75 kV, gold (second material 7b with a K-edge 9 at 80.73 keV) from 75 kV to 85 kV and lead (second material 7a with a K-edge 9 at 88.00 keV) from 85 kV to 95 kV. From this it can be seen, however, that the method according to the invention is limited in its possible voltage range—in particular with regard to its upper limit. It would be possible to go as far as uranium as material for the second filter 7; then, at approximately 115 kV, the highest high voltage that can be tested would be reached. Although it is possible to widen the measurement range with transuranic elements as filters, it does not make sense as the half-lives of the transuranic elements are generally much too short.

In addition, variations can also be made with respect to different voltage ranges of the prefilters 3. For example, it is possible to use no prefilter 3 up to a voltage of 65 kV, then a prefilter 3 made of 2 mm iron and, in addition, a prefilter 3 made of 3 mm iron for the voltage range from 65 kV to 75 kV. A better beam hardening is thus achieved, and the photoelectric effect can be detected more quickly.

According to the invention, an additional calculation is effected, of the difference in the value of the high voltage set at the high-voltage generator (the nominal value of the high voltage) for the recorded X-ray image, for which it was determined that it belongs to the K-edge 9 of the second material 7a-f considered. Finally, this nominal value of the high voltage at the high-voltage generator is corrected by the calculated difference.

In summary, it can be stated that the basis of the method according to the invention is the photoelectric effect. Here the material-specific absorption edges (in particular the K-edges 9) of various elements are used in order to measure the high voltage actually applied at the high-voltage generator; this generally differs from the nominally indicated high voltage. The measuring equipment is restricted here to the instruments which are available in a standard X-ray system (X-ray detector 5 and X-ray tube 1). The only additional measuring equipment (apart from the optional prefilter 3 for the beam hardening) is a filter set 4 which contains filters 6, 7 of various materials 6a, 7a-7f The signals behind the various filters 6, 7 are measured and from these measurement data the actual high voltage applied at the high-voltage generator is determined. By subtracting the determined actual high-voltage value from the nominal value set at the high-voltage generator, the offset between the two values can be determined and a calibration of the high-voltage generator can be carried out.

The method according to the invention represents a good way of testing the high voltage of an X-ray system. The greatest advantage in comparison with the voltage-divider method lies in the manageability of the measuring equipment. In the case of the voltage-divider method, two high-voltage cables, the voltage divider and a voltmeter are required, whereas the filter set 4 with a size of 200 mm×130 mm×10 mm and a weight of approximately 300 g in the case of the method according to the invention is easy to store and to transport. The remaining measuring equipment is available in the system. A further great advantage is that the filter set 4 does not have to be calibrated, as the K-edges 9 are material constants which do not change under any circumstances. Even if, for example, the rare earths oxidize, there is no change in the position of the K-edge 9. The K-edge 9 of oxygen would merely be added. However, as this is far away from the K-edges 9 of the rare earths, this would not affect the measurements. A further advantage of the method according to the invention is that the additional equipment required, i.e. the filter set 4 can be built into any conventional system currently available on the market. Regular and fully automatic testing of the high voltage could thus take place. From the point of view of radiation protection, the safety of the cubicles is increased as an incorrect excessive voltage which can lead to radiation leaks would be discovered with this method. The data obtained can also be used as early indications of failures or other problems of the high-voltage generator.

### LIST OF REFERENCE NUMBERS

1 X-ray tube
2 X-ray beam
3 prefilter
4 filter set
5 X-ray detector
6 first filter
6a first material
7 second filter
7a-f second material
8 carrier plate
9 K-edge
10 calibration range

1. Method for the calibration of a high-voltage generator of an X-ray tube (1) in a tube-detector system in a predefinable high-voltage range with the following steps:
a) introducing a filter set (4) with at least two filters (6, 7) made of different materials (6a, 7a-f) into the X-ray beam (2) between the X-ray tube (1) and an X-ray detector (5), wherein the first material (6a) of the first filter (6) has its K-edge (9) outside the predefinable high-voltage range and the second material (7a-f) of the second filter (7) has its K-edge (9) inside the predefinable high-voltage range;
b) setting a nominal value of the high voltage at the high-voltage generator of the X-ray tube (1) and recording an X-ray image of the filter set (4) through the X-ray detector (5);
c) recording further X-ray images of the filter set (4) at other nominal values of the high voltage at the high-voltage generator of the X-ray tube (1);
d) forming the relationship between the signals in the X-ray images for the first material (6a) and the second material (7a-f) for each individual nominal value of the high voltage;
e) determining the nominal value of the high voltage by reference to the setting at the high-voltage generator, at which the relationship has an extreme value;
f) calculating the difference between this nominal value of the high voltage and the value of the K-edge (9) of the second material (7a-f); and
g) correcting the nominal value of the high voltage by the calculated difference.

2. The method according to claim 1, wherein a prefilter (3) for the beam hardening of the X-ray beam (2) is introduced between X-ray tube (1) and X-ray detector (5).

3. The method according to claim 2, wherein the prefilter (3) is made of iron, copper or aluminum.

4. The method according to claim 2, wherein the prefilter (3) has a thickness in the range of from 0.1 mm to 10 mm, preferably between 0.1 mm and 3 mm.

5. The method according to claim 1, wherein the nominal values of the high voltage are passed through either in ascending or descending order.

6. The method according to claim 1, wherein the second material (7a-f) of the filter set (4) is selected from the following group of materials: uranium, thorium, bismuth, lead, thallium, mercury, gold, platinum, iridium, tungsten, tantalum, erbium, gadolinium, neodymium, cerium, barium, tellurium, tin, silver, palladium, molybdenum.

7. The method according to claim 6, wherein the filter set (4) has a further two filters (7) from the named group of second materials (7a-f).

8. The method according to claim 1, wherein the first material (6a) of the filter set (4) is copper.

9. The method according to claim 1, wherein at least one of the filters (6, 7) of the filter set (4) has a thickness in the range 1 μm to 10 mm, preferably between 10 μm and 2 mm.
